(19) United States
(12) Patent Application Publication
(10) Pub. No.: US 2018/0083567 A1
(43) Pub. Date: Mar. 22, 2018

(54) MOBILE SOLAR POWER SYSTEM AND METHOD FOR DEPLOYING SAME

(71) Applicant: SolaRover, Inc., Lone Tree, CO (US)

(72) Inventor: John S. Spisak, Lone Tree, CO (US)

(73) Assignee: SolaRover, Inc., Lone Tree, CO (US)

(21) Appl. No.: 15/728,378

(22) Filed: Oct. 9, 2017

Related U.S. Application Data
(63) Continuation-in-part of application No. 14/504,888, filed on Oct. 2, 2014, now abandoned.
(60) Provisional application No. 61/885,783, filed on Oct. 2, 2013.
(60) Provisional application No. 61/885,801, filed on Oct. 2, 2013.
(60) Provisional application No. 61/885,823, filed on Oct. 2, 2013.

(51) Int. Cl. H02S 10/40; B62D 63/06; H02S 20/30

(52) U.S. Cl. CPC H02S 10/40; H02S 20/30; B62D 63/062

(57) ABSTRACT

A mobile solar power system provides electricity to various electronic devices needing a source of electricity in remote locations. The mobile solar power system may be transported in a compact form to a remote location by a trailer configured for securely transporting the mobile solar power system. Arrays for containing solar panels may be attached to the mobile solar power system. When a user is ready to deploy the solar panels of the various arrays, the arrays may be slid out from the mobile solar power system and/or unfolded from the mobile solar power system. After the arrays are deployed, the arrays including solar panels may be angled such that the solar panels may be exposed to solar energy which may be subsequently passed through to the various electronic devices needing a source of electricity.

### CROSS-REFERENCE TO RELATED APPLICATIONS

The present invention is a continuation-in-part of U.S. patent application Ser. No. 14/504,888 filed on Oct. 2, 2014, which claims priority to U.S. Provisional Patent Application No. 61/885,783, filed on Oct. 2, 2013; U.S. Provisional Patent Application No. 61/885,801, filed on Oct. 2, 2013; and U.S. Provisional Patent Application No. 61/885,823, filed on Oct. 2, 2013. The entire disclosures of each of the above-referenced patent applications are incorporated herein by reference as though set forth fully herein.

### FIELD OF INVENTION

The present invention relates generally to the field of power systems. More specifically, the present invention relates to a mobile solar power system having a compact, transportable trailer, and which may be quickly and readily deployed in the field.

### BACKGROUND OF INVENTION

In recent years, a significant movement toward development of power through alternative energy sources such as solar power generation has arisen. However, solar power generation systems have several drawbacks. One particularly relevant drawback is that conventional systems are not designed for easy transportation from one generation site to another. Although various prior art systems have been disclosed which attempt to address this transportation issue, the prior art systems are not sufficiently compact or transportable.

For example, systems disclosed in U.S. Pat. No. 7,492,120 B2 and United States Patent Application Publication No. US 2011/0057512 A1 do not provide for a sufficiently large deployed footprint from a sufficiently small transport footprint. Thus, energy collecting capacity is smaller than desired, and the package size is larger than desired. A survey of the prior art suggests that the current deployed-to-transport footprint ratio is approximately 1.5/1 to 3/1, meaning that the fully deployed footprint is 1.5 to 3 times the size of the transport footprint. This ratio is smaller than desired.

Another drawback of conventional mobile power systems is difficulty of deployment once the systems are transported to a specific site. Setup time may be measured in hours and typically requires a crew of three or more individuals to deploy the heavy solar energy gathering panels. Such setup is more difficult and time consuming than is desired.

Accordingly, a need has arisen for a mobile solar power system that provides a better deployed-to-transport ratio than is seen in the prior art, coupled with ease of self-deployment by a single person into operating configuration in less time than is needed with the prior art, particularly in emergency situations.

### SUMMARY OF INVENTION

The present invention relates to the field of mobile solar power systems. More specifically, the present invention relates to a method of transporting a mobile solar power system to a desired remote location, where a plurality of arrays including solar panels contained therein may be slid out from and/or unfolded from the mobile solar power system. The mobile solar, power system may be transported by a trailer adapted to transport the mobile solar power system. The trailer may include outriggers and jacks that may be used to level and stabilize the mobile solar power system after it has been delivered to a desired location.

In one embodiment, the mobile solar power system may include a front sliding array and a rear sliding array that may slide out from the mobile solar power system. The mobile solar power system may also include at least two left folding arrays and at least two right folding arrays that may be attached to the left and right side portions, respectively, of the mobile solar power system in a folded position. After the front sliding array and rear sliding array are slid out from the mobile solar power system, the left and right folding arrays may be unfolded from one another such that they may be in substantial longitudinally alignment with one another. The unfolded left and right folding arrays may subsequently be extended from the sides of the mobile solar power system.

Next, an angled actuator within the mobile solar power system may be used to tilt the various arrays which include solar panels to a desired angle. The solar panels of the arrays may absorb solar power which may subsequently be used by external electronic devices needing electricity when the external electronic devices are connected to an electronic panel associated with the mobile solar power system.

In an alternative embodiment, the mobile solar power system may include sliding arrays that overlap when stowed in a compact form within the mobile solar power system prior to deployment. The sliding arrays may extend from the sides of the mobile solar power system when deployed. Similarly to the embodiment described above, the sliding arrays may include solar panels therein. When the sliding arrays are extended from the sides of the mobile solar power system, a center panel of the mobile solar power system, which was previously positioned, located, and stowed under the sliding arrays, may be exposed. The center panel may also include a solar panel contained therein for absorbing solar power. An angled actuator located within the mobile solar power system may subsequently tilt the sliding arrays and center panel such that they may be angled at a desired location to sufficiently absorb solar energy from the sun.

In both described embodiments above, the arrays and/or panels of the mobile solar power system may be stored compactly until ready for deployment. When deployed, the arrays and/or panels provide for a sufficiently large energy collecting area.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 illustrates a mobile solar power system according to the teachings of the present invention.

FIG. 2 illustrates a leveling outrigger of the mobile solar power system of FIG. 1 in a locked, stowed position.

FIG. 3 illustrates an outrigger of the mobile solar power system of FIG. 1 in a deployed position.

FIG. 4 illustrates a jack of the mobile solar power system of FIG. 1 in a locked, stowed position.

FIG. 5 illustrates a jack of the mobile solar power system of FIG. 1 in a deployed position.

FIG. 6 illustrates a front sliding array of the mobile solar power system of FIG. 1 in a locked, stowed position.

FIG. 7 illustrates a side elevation view of the front sliding array and rear sliding array extending from the mobile solar power system of FIG. 1.

FIG. 8 illustrates a bottom plan view of the front sliding array and rear sliding array extending from the mobile solar power system of FIG. 1.

FIG. 9 illustrates a wing arm tip of a wing arm attached to the underside of the front sliding array of FIG. 7.

FIG. 10 illustrates the wing arm tip of FIG. 9 when it has been unattached from the front sliding array and attached to a lower frame of the mobile solar power system of FIG. 1.

FIG. 11 illustrates portions of the underside of the front sliding array and the wing arm of FIGS. 7 and 8 including rotational slide pins associated therewith.

FIG. 12 illustrates a rotational slide pin illustrated of FIG. 11 in a locked position.

FIG. 13 illustrates the rotational slide pin of FIG. 12 in an unlocked position.

FIG. 14 is a bottom perspective view of the underside of the front sliding array.

FIG. 15 is an enlarged perspective view of a portion of the underside of the array shown in FIG. 14 depicting the elements of a track member in greater detail.

FIG. 16 is a side view of a portion of the underside of the array shown in FIG. 14 depicting the track member secured thereto.

FIG. 17 illustrates a rear sliding array of the mobile solar power system of FIG. 1 in a locked, stowed position.

FIG. 18 illustrates a perspective view of the front sliding array and rear sliding array extending from the mobile solar power system of FIG. 1.

FIG. 19 illustrates left folding arrays of the mobile solar power system of FIG. 1 when the folding arrays have been unfolded, engaged with one another, and deployed.

FIG. 20 illustrates left folding arrays of the mobile solar power system of FIG. 19 in a latched position.

FIG. 21 illustrates an outer folding array unfolded and adjacent to a center folding array of the left folding arrays of FIG. 19.

FIG. 22 illustrates the wing arm and wing arm tip of FIG. 21 attached to the center folding array of FIG. 19.

FIG. 23 illustrates a remote control for extending, retracting, and tilting the left and right folding arrays of the mobile solar power system of FIG. 1.

FIG. 24 illustrates a perspective view of left folding arrays of the mobile solar power system of FIG. 1 in an extended position.

FIG. 25 illustrates a perspective view of left and right folding arrays of the mobile solar power system of FIG. 1 in an extended position.

FIG. 26 illustrates a side elevation view of the left folding arrays, center array, and right folding arrays of the mobile solar power system of FIG. 1 in an extended and tilted position.

FIG. 27 illustrates an alternative embodiment of the mobile solar power system of FIG. 1.

FIG. 28 illustrates left and right slide arrays of the mobile solar power system of FIG. 27 in an extended, secured position.

FIG. 29 illustrates a locking mechanism for securing a slide array of the mobile solar power system of FIGS. 27 and 28.

FIG. 30 illustrates a slide array of the mobile solar power system of FIGS. 27 and 28 in an extended, secured position.

FIG. 31 illustrates an angle guide for adjusting the angle of the left and right side arrays, and center panel of the mobile solar power system of FIG. 27.

FIG. 32 illustrates the left and right side arrays, and center panel of the mobile solar power system of FIG. 27 as the arrays and panel are adjusted to a particular angle.

FIG. 33 illustrates the left and right side arrays, and center panel of the mobile solar power system of FIG. 27 when the arrays and panel have been fully adjusted to a particular angle.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention.

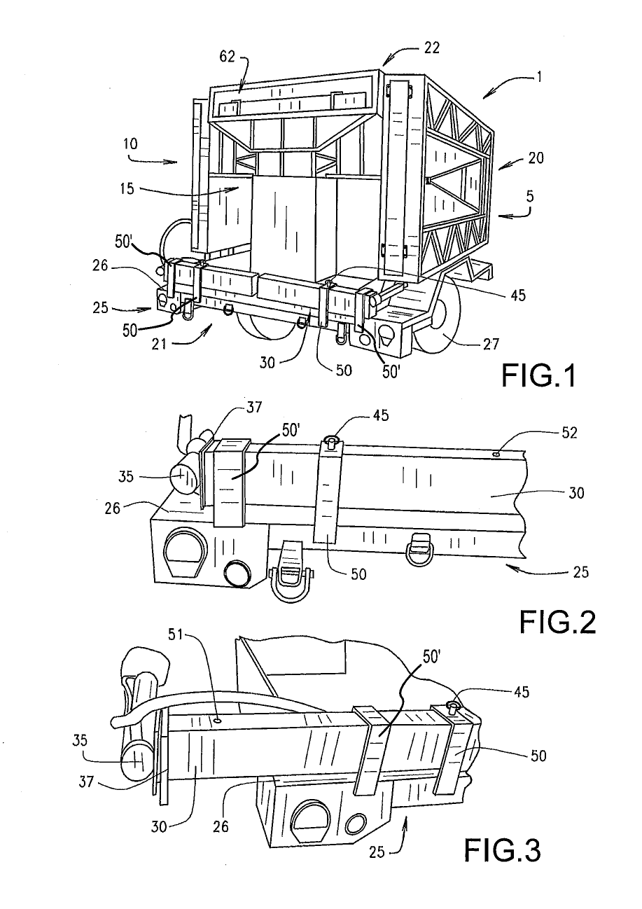

FIG. 1 illustrates a mobile solar power system 1, hereinafter referred to as simply “the power system” or “the unit”). The power system may be constructed so that it may be easily transported in the compact form illustrated in FIG. 1 until it is delivered to a deployment location. The power system 1 may include a right portion 5, a left portion 10, a front portion 15, a rear portion 20, a bottom portion 21 and a top portion 22. The power system is structured and arranged to be transportable by being mounted on a trailer 25, the trailer 25 being adapted to receive and secure the unit, as is known in the art.

Trailer 25 may be attached to a truck or other towing vehicle to facilitate towing the power system to a desired location for deployment. By way of example and not of limitation, trailer 25 may include a deck, which is illustrated herein at 26 for reference. The deck may include reinforcing hitching mechanisms such as towing latches having chains, ropes and the like secured thereto which may further secure the trailer to a truck or towing vehicle.

In at least one alternative embodiment, wheels 27 for transporting mobile solar power system 1 and a hitch for hauling it behind a truck or other towing vehicle may be integral with mobile solar power system 1. In that embodiment, trailer 25 is not necessary.

After the solar power system is delivered to a desired location, trailer 25 may be uncoupled from the truck or towing vehicle, and the wheels chocked or otherwise secured to prevent undesired movement thereof prior to deployment of the system, as will be described below.

Before deployment, a user may inspect the solar power system looking for any damaged or loose structural items, any damaged wiring, any signs of hydraulic leaks, any damaged hydraulic hoses, and so forth to ensure that all enclosures are not damaged or missing.

After a thorough inspection, a user may begin to deploy leveling outriggers 30 associated with front portion 15 and rear portion 20 of mobile solar power system 1, an exemplary embodiment of which is illustrated in FIGS. 2 and 3. Leveling outriggers 30 may be used to stabilize and level trailer 25 and mobile solar power system 1 when mobile solar power system 1 has been hauled to a desired location. Leveling outriggers 30 may include jacks 35, which may be attached to outriggers 30. In the embodiment shown, the power system 1 includes four leveling outriggers 30 and four jacks 35 attached thereto; although, more or fewer outriggers 30 and jacks 35 may be used without departing from the scope of the present invention.

In order to deploy outriggers 30, a user would first remove a top pin 45 associated with an inner bracket 50. Top pin 45 and bracket 50 may keep leveling outriggers 30 in a locked, stowed position when the unit is in transit or is otherwise in a transportation configuration prior to deployment. Following removal of top pin 45 from bracket 50, a user may slide a leveling outrigger 30 out and away from the system via a friction fit within inner bracket 50 and an outer bracket 50′ such that each leveling outrigger will be substantially perpendicular to trailer 25, as illustrated in FIG. 3.

Top pin 45 is positioned in aperture 51 (FIG. 3) of outrigger 30 when outrigger 30 is in the locked, stowed position illustrated in FIG. 2. As each of the four leveling outriggers 30 are deployed, each leveling outrigger 30 is preferably re-attached to bracket 50 by inserting pin 45 into a second aperture 52 of outrigger 30 when outrigger 30 is in the deployed position illustrated in FIG. 3. Other means for deploying leveling outriggers 30 such as using a rail mechanism to slide the outriggers or other attachment means may also be employed without departing from the scope hereof.

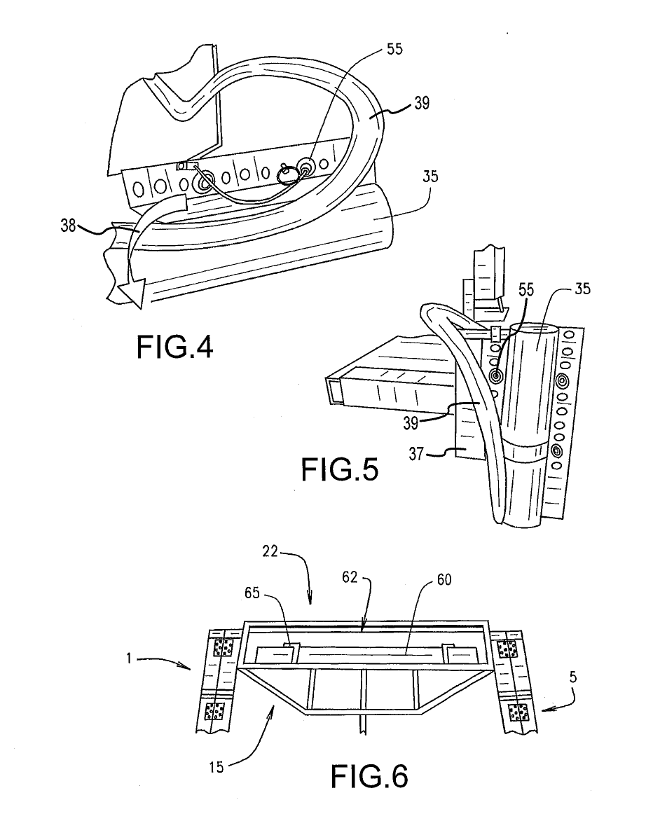

After deploying leveling outriggers 30, a user may deploy a jack 35 connected to an end 37 of each leveling outrigger 30 respectively. To do so, a user may first remove a front pin 55 associated with each jack 35 that pins the jack in a locked, stowed position to a respective outrigger end 37 during transport, as shown in FIGS. 3 and 4. After removing each front pin 55, a user may rotate each jack 35 downward in a direction shown by arrow 38 until it is substantially perpendicular to a ground surface and its associated outrigger 30 as shown in FIG. 5, whereupon front pin 55 is reinserted into end 37 of the outrigger in order to secure a jack 35 in its deployed position. The process for deploying jacks 35 may be repeated until all four jacks 35 are deployed and further secured. Other non-limiting mechanisms similar to using front pins 55 may also be used to secure jacks 35 in either their locked, stowed position or deployed position.

With four jacks 35 deployed and secured, a user may begin the process of leveling the mobile solar power system 1 and trailer 25. Typically, a user will open an electrical enclosure (not illustrated) associated with the power system. The electrical enclosure may include a control device to activate hydraulic mechanisms attached to the power system or the trailer whereby pressurized hydraulic fluid is delivered to each of the jacks via respective hydraulic lines 39 to automatically level the trailer and the system on a variety of ground surfaces. While hydraulic mechanisms are preferably used to level trailer 25 and mobile solar power system 1, other systems are further contemplated herein. For example, pneumatic systems or other mechanical leveling mechanisms known in the art may be used.

After mobile solar power system 1 is leveled, a user may begin the process of using a combination of sliding and folding techniques to deploy solar panels contained within a plurality of arrays. A user may begin by deploying a front sliding array 60 from the front portion 15 of mobile solar power system 1. Front sliding array 60 is illustrated in its locked and stowed position in FIG. 6, which shows the top portion 22 of mobile solar power system of FIG. 1. In FIG. 6, front sliding array 60 may be stowed within a housing 62 in the top portion 22 of the unit. Housing 62 stores front sliding array 60 and rear sliding array 100 (described below) when arrays 60, 100 are in their locked and stowed positions.

In the illustrated embodiment, front sliding array 60 is held in its stowed position by two slide bolts 65. To begin deploying front sliding array 60, a user may first disengage slide bolts 65. Slide bolts 65 are L-shaped in the present embodiment, though other varieties and shapes of bolts for securing front sliding array 60 in a stowed position may be used in alternative embodiments. Once slide bolts 65 have been disengaged, front sliding array 60 may be pulled outwardly and away from front portion 15 such that front sliding array 60 may slide out from mobile solar power system 1 and extend therefrom. After the sliding array 60 has been slid fully outwardly, it may be attached to the system, as will be described below in greater detail. Front sliding array 60 is preferably slid out from housing 62 using tracks and rails in a manner known in the art, though other sliding means such as roller ball bearings, wheels, and other non-limiting mechanisms may be used.

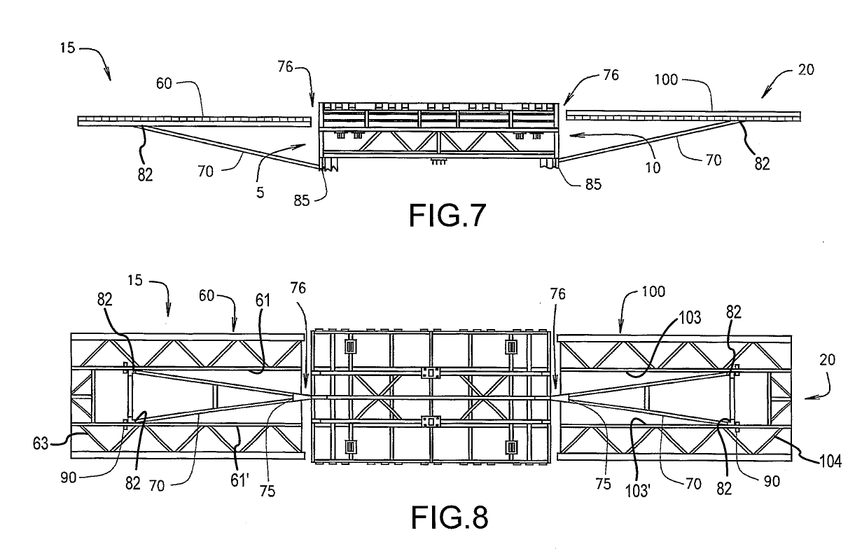

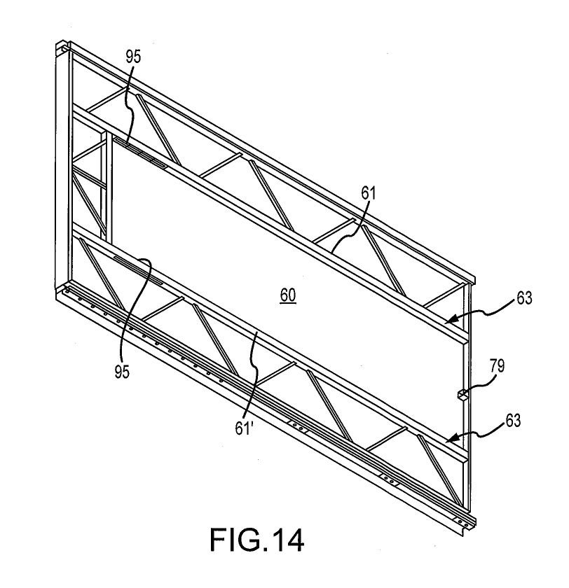

FIGS. 7 and 8 illustrate front sliding array 60 and a rear sliding array 100 extending from front and rear portions 15, 20 respectively of mobile solar power system 1 in a deployed position. As illustrated in FIG. 7, when front sliding array 60 and rear sliding array 100 are deployed, they may be parallel to one another (and a ground surface) but lie in different horizontal planes as a result of front sliding array 60 being positioned, located, and stored under rear sliding array 100 in a stacked arrangement when arrays 60, 100 are stowed in housing 62, as illustrated in FIGS. 1, 6 and 14. FIGS. 7 and 8 further illustrate wing arms 70 associated with each array 60, 100 supporting and stabilizing the arrays 60, 100 in their extended, deployed positions. In the embodiment shown, wing arms 70 are generally wishbone or y-shaped, however, other shapes may be used without departing from the scope hereof. Their methods of operation will be described in greater detail as additional drawings hereof are described.

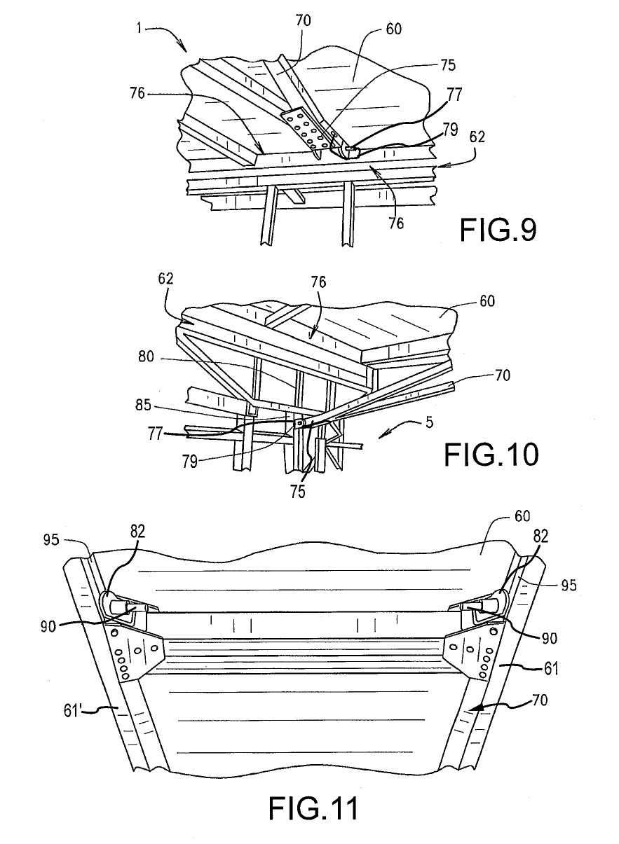

FIG. 9 illustrates the underside of front sliding array 60 as deployed from mobile solar power system 1, and it further illustrates a wing arm 70 positioned on the underside of front sliding array 60 and attached thereto. As illustrated, the front sliding array 60 may be slid out and away from housing 62, and a wing arm tip 75 of wing arm 70 may be pinned to the underside of front sliding array 60 for stowage during transportation, for example to proximal portions 76 of array 60 by a pin 77 and cooperating bracket 79. Wing arm tip 75 may then be attached to a lower frame member 85 of the unit, as array 60, is deployed, as described below. As shown in FIGS. 11-14, each wing arm further includes a pair of spaced-apart distal end portions 82 which are rotatably and slideably pinned or hinged to the array 60.

Wing arm tip 75 may be unpinned from the underside of front sliding array 60 after front sliding array 60 has been slid sufficiently outwardly and away from the unit. After unpinning wing arm tip 75, wing arm tip 75 and wing arm 70 may be rotated downwardly as illustrated in FIG. 10. When wing arm 70 and wing arm tip 75 have been sufficiently rotated past an upper frame member 80 and to a lower frame 85, wing arm tip 75 may be attached to the lower frame 85, for example, by inserting the pin 77 into another cooperating bracket 79′ secured to the lower frame 85. However, other means and mechanisms for releasably attaching wing arm tip 75 to lower frame 85 may also be used without departing from the scope hereof.

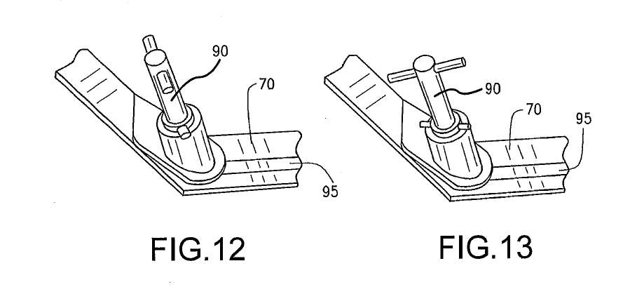

FIG. 11 illustrates the spaced-apart distal portions 82 of wing arm 70 in greater detail. More specifically, FIG. 11 illustrates a rotational slide pin 90, attached to each of the ends 82 which supports and reinforces front sliding array 60 in an extended, deployed position. As illustrated in greater detail in FIGS. 12 and 13, the pins 90 may be spring-loaded. After wing arm tip 75 has been attached to lower frame 85 in the manner described hereinabove, front sliding array 60 may be rotated upwardly. As front sliding array 60 is rotated upwardly, each of rotational slide pins 90 slide within a respective track 95 secured to a respective on of first and second frame members 61, 61′ of a frame structure 63 supporting array 60.

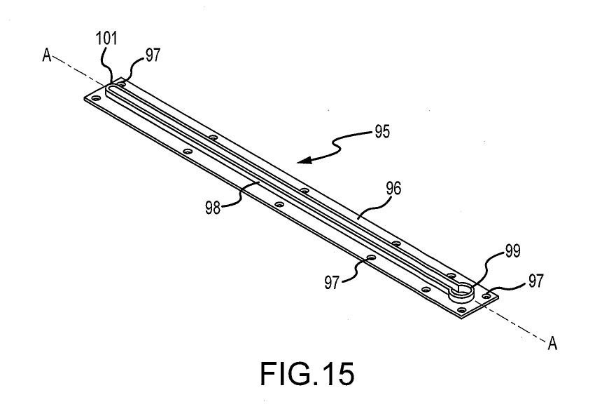

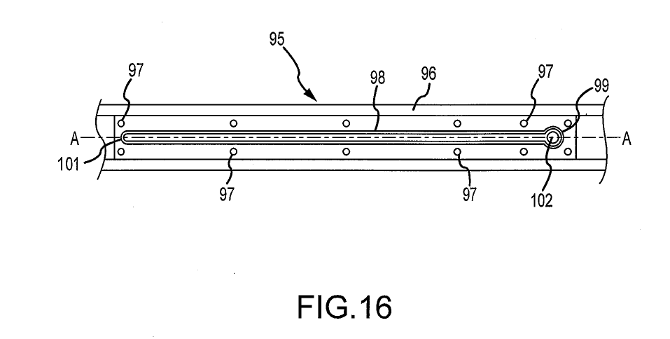

Referring to FIGS. 15 and 16, the elements of track 95 are shown in greater detail. The track includes a flat body or plate member 96 along and systemically about a longitudinal axis A-A. The plate member includes a plurality of substantially longitudinally and laterally spaced-apart apertures 97 framed therein, each of the plurality of apertures being adapted to receive a fastening member, for example a bolt or screw, to secure the track to a respective one of the frame members 61,61′. Each track 95 further includes a channel member or guide 98 extending substantially vertically outwardly away from the plate 96 and along and systematically about longitudinal axis A-A. Each guide is structured and arranged to slideably receive a respective one of the pins 90 and to guide it along the associated frame member 61,61′ to which it is attached while front sliding array 60 is being extended for deployment or retracted for stowing and transport.

The channel member includes first and second rounded, closed ends 99, 101 which serve as stops to the track of pin 90 as the front sliding array is either deployed or retracted. The first closed end 99 is of an enlarged, generally circular configuration for receiving and guiding an associated pin 90 into at least one aperture 102 formed in each of the frame members 61, 61′. In the embodiment of FIG. 16, aperture 102 is aligned concentrically with the first closed end of the channel or guide of the track. Once front sliding array 60 has been rotated upwardly such that it is substantially parallel with a ground surface, as illustrated in FIGS. 7 and 8, the spring-loaded slide pins 90 pop into the aperture 102 formed in the frame member 61, 61′. The apertures may be positioned and located such that rotational slide pins 90 pop into them when front sliding array 60 is parallel to a ground surface; however, other apertures may be provided which cooperate with pins 90 to secure the sliding array at angles other than parallel to the ground. Other means for securing front sliding array 60, such as a latching device, track mechanism, or rail system, may be used to secure front sliding array 60 substantially parallel to a ground surface.

FIGS. 12 and 13, the rotational slide pins 90 illustrated in FIG. 11 may be in an open position or a closed position. FIG. 12 illustrates a rotational slide pin 90 in a closed position, and FIG. 13 illustrates a rotational slide pin 90 in an open position. It should be noted that in order to utilize the spring function of rotational slide pins 90 described herein, each rotational slide pin 90 should be in the open position illustrated in FIG. 13.

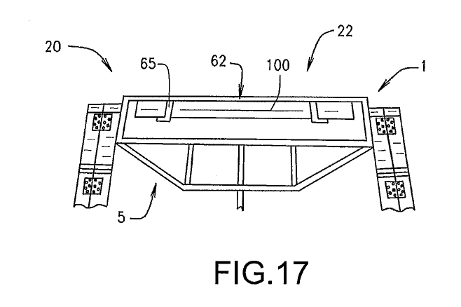

FIG. 17 illustrates a locked, stowed rear sliding array 100 within housing 62 of mobile solar power system 1 and secured by slide bolts 65 substantially similar to those holding front sliding array 60 in its locked, stowed position within housing 62 illustrated in FIG. 6. Rear sliding array 100 may be positioned and located on top of front sliding array 60 when both arrays 60 and 100 are in the compact stowed configuration within housing 62, as illustrated in FIG. 1.

After front sliding array 60 has been deployed in the manner described hereinabove, rear sliding array 100 may also be deployed in substantially the same manner as front sliding array 60. After releasing rear sliding array 100 by unsecuring slide bolts 65, and releasing wing arm 70 from the underside of rear sliding array 100 via wing tip 75, rear sliding array 100 may be secured to lower frame 85 on rear portion 20 of the unit in a substantially similar manner to that described above the front sliding array. Rotational slide pins 90 substantially similar to those described hereinabove may also slide along track 95 secured to a respective frame member 103, 103′ of a frame structure 104 supporting array 100. When rear sliding array 100 is substantially parallel to the ground, slide pins 90 pop into apertures formed in each of the frame members 103, 103′ in the same manner described hereinabove with respect to array 60 to reinforce rear sliding array 100 in an extended, deployed position.

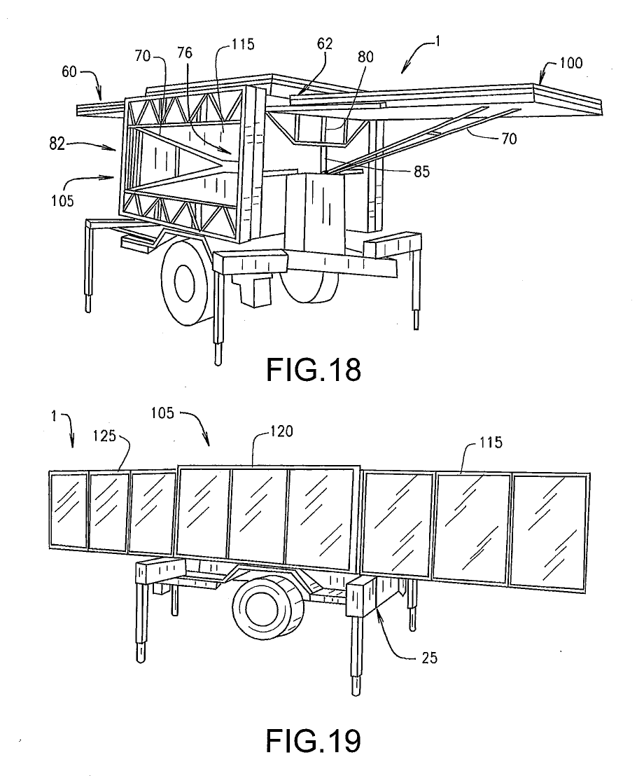

FIG. 18 illustrates the mobile solar power system 1 when arrays 60, 100 have been extended and deployed. After arrays 60, 100 have been deployed, a user may begin the process of deploying left and right folding arrays. Left folding arrays 105 are illustrated in a folded configuration in FIG. 18. FIG. 19 illustrates an outer folding array 115, center folding array 120, and inner folding array 125 of left folding array 105 when they have been unfolded and deployed in the manner described herein below. When both outer folding array 115 and inner folding array 125 have been unfolded, the unit may appear as illustrated in FIG. 19. It should be noted that while outer folding tray 115 and inner folding tray 125 are parallel to center folding tray 120, they may not lie in the same vertical plane. Moreover, it should also be noted that in the deployed position, center folding tray 120 may be in a vertical plane located distally outwardly with respect to the trailer and the planes of the outer folding tray 115 and inner folding tray 125.

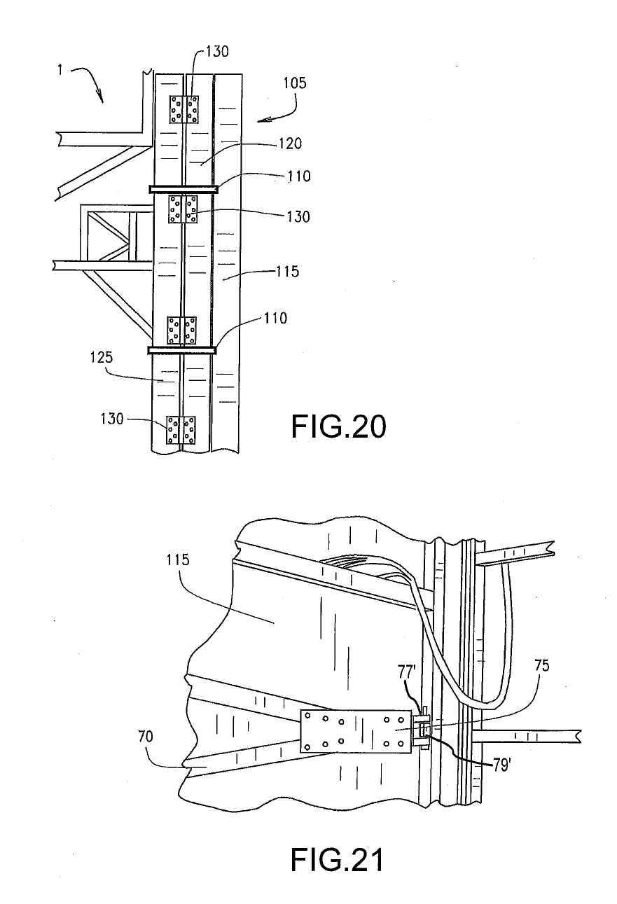

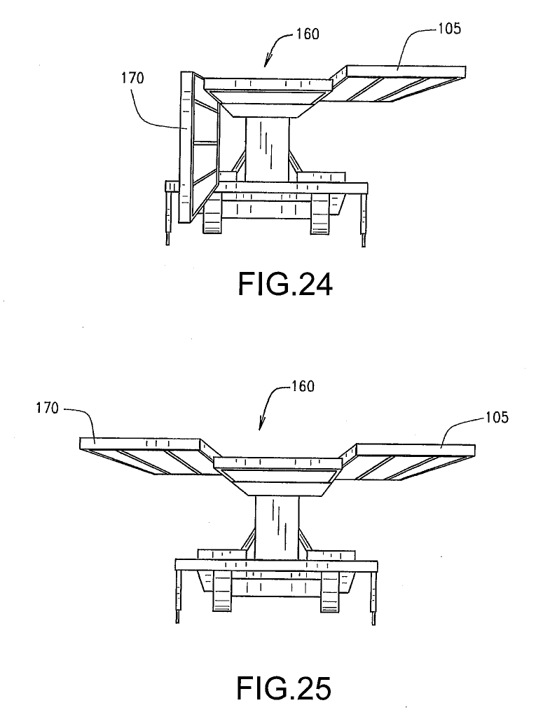

FIG. 20 illustrates a portion of mobile solar power system 1 showing left folding arrays 105 in a folded, compact configuration. Mobile solar power system 1 may include left folding arrays 105 and right folding arrays (illustrated in FIG. 24), which are attached to the left portion 10 and right portion 5, respectively, of the unit. Left folding arrays 105 may be positioned and held in a folded, compact position by latches 110 associated therewith. Latches 110 may prevent left folding arrays 105 from unfolding while mobile solar power system 1 is in transit or otherwise is unready for unfolding and deployment. Latches 110 may be of any variety known in the art. Other non-limiting mechanisms for securing left folding arrays 105 in a folded position are considered herein.

In order to begin the process of unfolding left folding arrays 105, the latches 110 may be unlatched. Outer folding array 115 may first be unfolded via a hinge positioned and located on the back of left folding arrays 105 (not illustrated). The hinge located on the back of left folding arrays 105 may attach outer folding array 115 with center folding array 120. As illustrated in FIG. 20, inner folding array 125 may further be attached to center folding array 120 via hinges 130. In the preferred embodiment, by way of example and not of limitation, center folding array 120 and inner folding array 125 are attached via four hinges 130; although embodiments employing a greater or lesser number of hinges are contemplated herein. Once outer folding array 115 is unlatched, it may be pushed outwardly around the hinge attaching it to center folding tray 120 until it is substantially parallel with center folding array 120.

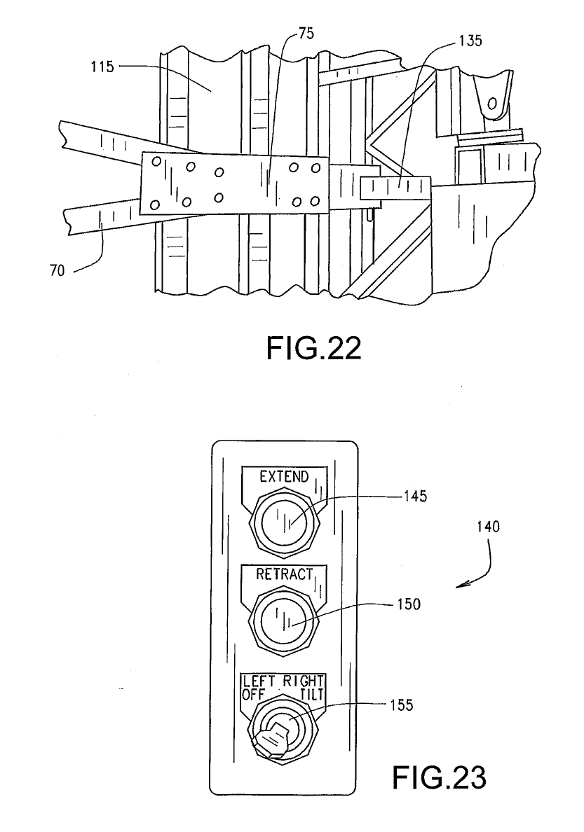

As illustrated in FIG. 18, and shown in greater detail in FIG. 21, outer folding array 115 may include a wing arm 70 substantially similar to the wing arm 70 described and associated with front sliding array 60. FIG. 21 illustrates outer folding array 115 and its wing arm 70 when wing arm tip 75 is attached to the back of outer folding array 115 via a cooperating pin 77′ and bracket 79′ as herein above described. As outer folding tray 115 is folded outward such that it is parallel with center folding array 120, wing arm tip 75 may be reattached to a center folding array frame 135 via pin 77′, as illustrated in FIG. 22. Attaching wing arm tip 75 to center folding array frame 135 may be substantially similar in operation and function to attaching wing arm tip 75 to lower frame 85 as described above. When wing arm tip 75 associated with outer folding array 115 has been attached to center folding array frame 135, outer folding array 115 may be rotated to the point that it is no longer parallel with center folding array 120 and should be pushed outwardly such that it may return to being parallel with center folding array 120.

Wing arm 70 of outer folding array 115 may include rotational slide pins 90 and a track 95 substantially similar to those described above. When unlocked, rotational slide pins 90 may move within track 95 having the same structure and in the same manner as described above with respect to the deployment of rear and front folding arrays 60, 100. As outer folding tray 115 is returned to being parallel with center folding array 120, apertures formed in a supporting frame member secured to outer folding array 115 may be located such that rotational slide pins 90 pop into the apertures when outer folding array 115 is parallel with center folding array 120. As above, rotational slide pins 90, which may be spring-loaded, slide in a track 95 on the supporting frame member may with the apertures in line with track 95 to reinforce outer folding array 115 in its open, extended position.

After outer folding array 115 has been unfolded and deployed in its extended position, inner folding array 125 may be rotated about center folding tray 120 in a manner substantially similar to that described for outer folding array 115. Inner folding array 125 may be rotated around center folding array 120 via hinges 130. Attaching inner folding array 125 to center folding array 120 via arm 70 having a wing arm tip 75 rotational slide pins 90 and a track 95 is be substantially to the same as that described for outer folding array 115.

FIG. 23 illustrates a remote control 140 for operating various functions of mobile solar power system 1. Remote control 140 may include an extend button 145, a retract button 150 and a tilt button 155. As illustrated, tilt button 155 may include a left tilt function and a right tilt function. Other buttons which may effectively control various functions of mobile solar power system 1 may be included in alternative embodiments of remote control 140.

FIG. 24 illustrates extending left fold arrays 105 after outer folding array 115, center folding array 120 and inner folding array 125 have been unfolded and attached in the manner described hereinabove. As illustrated, left folding arrays 105 may be substantially parallel to a center array 160 of the power system 1. While left folding arrays 105 and center array 160 may be substantially parallel to one another, they may not lie in the same plane. Left folding arrays 105 may be extended via lateral actuators 165 (illustrated in FIG. 23), which may be controlled by remote control 140. In an embodiment, left folding arrays 105 may include two lateral actuators 165. One lateral actuator 165 may be positioned and located toward front portion 15 of the unit, and a second lateral actuator 165 may be positioned and located at rear portion 20 thereof. In other embodiments, mobile solar power system 1 may include more or fewer lateral actuators 165.

FIG. 24 also illustrates right folding arrays 170. Right folding arrays 170 may include an outer folding tray 115, center folding tray 120, and inner folding tray 125, wherein folding trays 115, 120, 125 unfold and attach to one another in a manner substantially similar to folding trays 115, 120, 125 associated with left folding arrays 105.

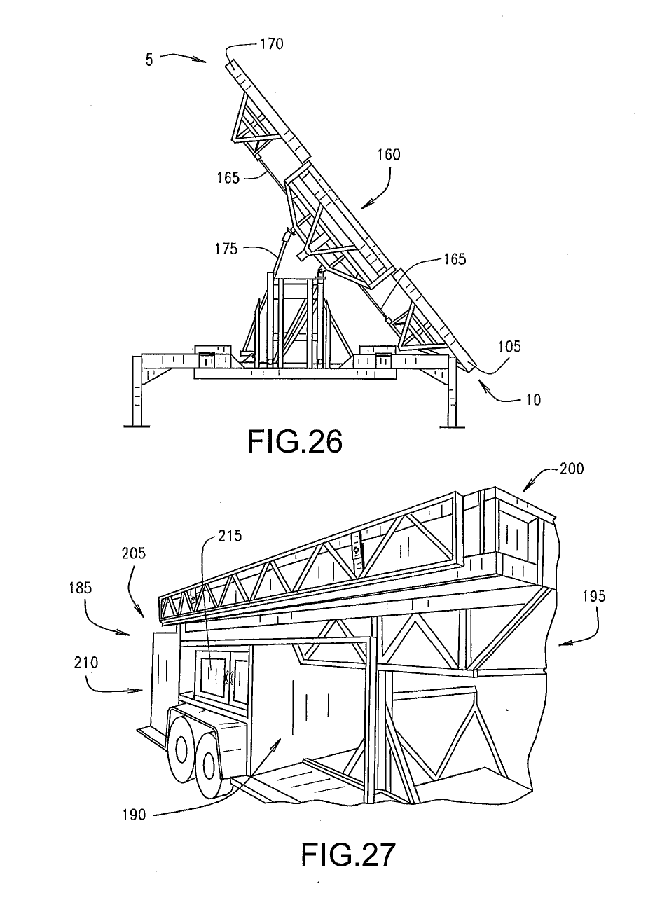

FIGS. 25 and 26 illustrate mobile solar power system 1 when left folding arrays 105 and right folding arrays 170 both have been extended via lateral actuators 165 which may be controlled by remote control 140. It should be noted that remote control 140 may activate lateral actuators 165, but lateral actuators 165 also may be operated via a hydraulic method according to an embodiment. In other embodiments, lateral actuators 165 may be operated pneumatically or by mechanical systems known in the art. Right folding arrays 170 may include two lateral actuators 165 positioned and located opposite from lateral actuators 165 associated with left folding arrays 105; however, more or fewer lateral actuators 165 may be associated with folding arrays 105, 170 without departing from the slope hereof.

FIG. 26 illustrates mobile solar power system 1 when remote control 140 (or manual means) has been used to tilt left folding arrays 105, right folding arrays 170 and center array 160 such that left folding arrays 105, right folding arrays 170 and center array 160 of mobile solar power system 1 are angled. When angled, left folding arrays 105, right folding arrays 170 and center array 160 may be exposed to sunlight at an angle of exposure desired by a user. When arrays 105, 170 and center array 160 have been tilted, they may be tilted from right portion 5 toward left portion 10 (as illustrated), or alternatively from left portion 10 to right portion 5. Remote control 140 may operate angled actuators 175, as illustrated in FIG. 26, to tilt left folding arrays 105, right folding arrays 170, and center array 160 to provide sunlight thereto. Angled actuators 175 may be operated hydraulically, although other control systems such as a pneumatic control system are further envisioned herein. In an embodiment, the hydraulic control system used to control angled actuators 175 may be operated via remote control 140; however, the hydraulic control system may be manually controlled.

Left folding arrays 105, right folding arrays 170 and the center array 160 include one or more of solar panels 180. It is the exposure of sunlight to these solar panels that provides the power to the power system 1. The interior of mobile solar power system 1 includes open space which may accommodate an electronic control box or other electronic component panel, as known in the art. An external component which requires electricity to be supplied thereto may be hooked up to the electronic control box in order to receive power. Multiple external components may draw electricity from the electronic control box. When the system 1 is no longer needed, a user may return mobile solar power system 1 to its compact form, such as illustrated in FIG. 1, by performing the methods described herein in reverse order. When the unit is returned to its compact form illustrated in FIG. 1, trailer 25 may be reattached to a truck or other towing vehicle in a manner known in the art such that the truck or towing vehicle may haul trailer 25 and mobile solar power system 1 mounted thereon to another desired location.

FIG. 27 illustrates another embodiment 185 of mobile solar power system in accordance with the teaching of the present invention. Mobile solar power system 185 includes a right portion 190, a left portion 195, a front portion 200, and a rear portion 205, and it may be mounted and attached to a trailer 210. Trailer 210 may be larger than trailer 25, as mobile solar power system 185 may be larger than mobile solar power system 1. FIG. 27 also illustrates an electronic compartment 215 associated with mobile solar power system 185. Electronic compartment 215 may include various electronic controls for deploying mobile solar power system 185 and also for attaching thereto various external components that may require electricity to be supplied thereto. In other embodiments, electronic compartment 215 may be positioned and located elsewhere on mobile solar power system 185 or positioned externally of mobile solar power system 185.

Trailer 210 and the system may be leveled in a manner substantially similar to that described for mobile solar power system 1. Power system 185 may include outriggers and jacks substantially similar to outriggers 30 and jacks 35 described herein above. The method for leveling mobile solar power system 185 using hydraulic means, or other non-limiting means may be substantially similar to those described above for mobile solar power system 1.

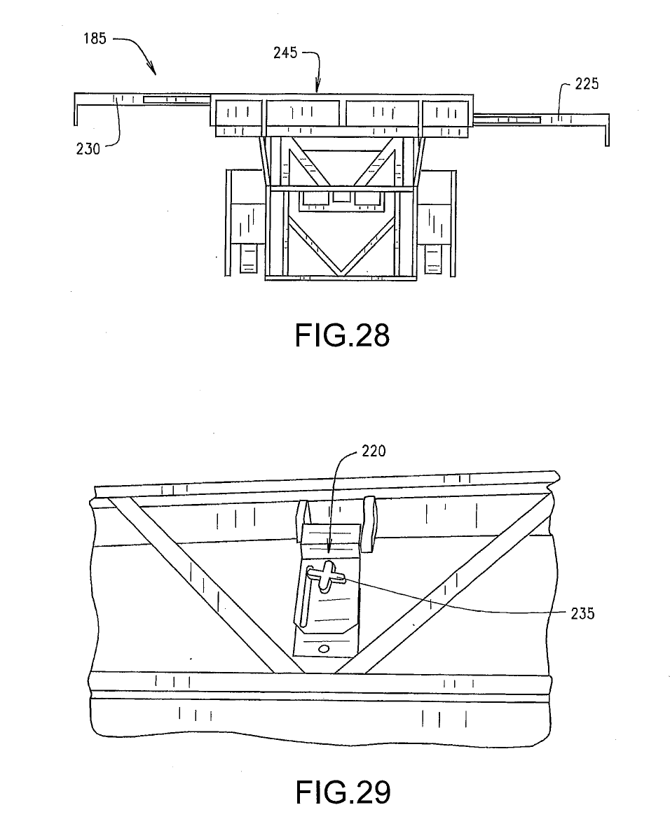

FIG. 28 illustrates mobile solar power system 185 when a right slide array 225 and a left slide array 230 both have been unlocked and extended therefrom. A center array 245 is also illustrated. The means by which right slide array 225 and left slide array 230 are extended and deployed, and center array 245 is exposed, are described herein below.

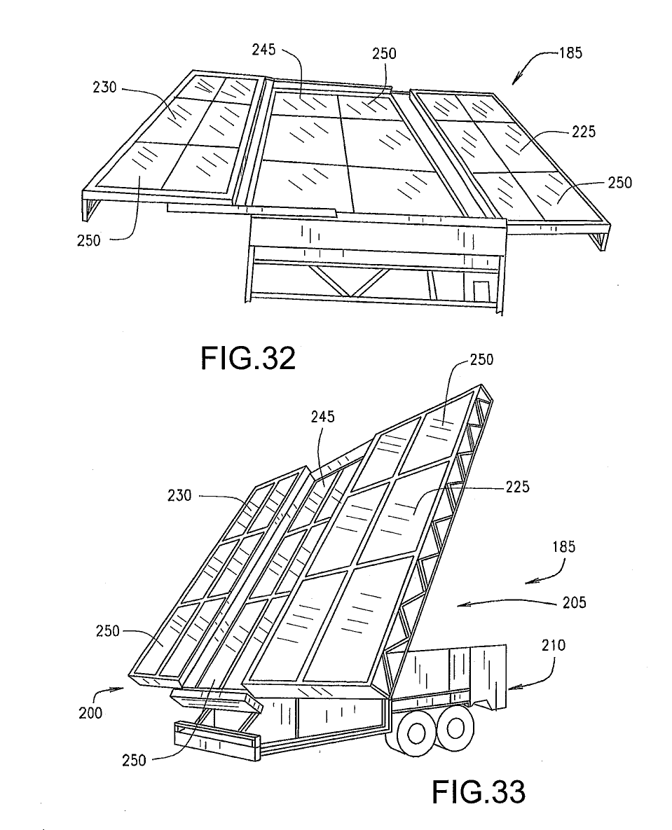

As illustrated in FIG. 28, right slide array 225 may be positioned and located below left slide array 230 when both arrays 225, 230 have been extended and deployed. Right slide array 225 and left slide array 230 may be complimentarily positioned such that when right slide array 225 and left slide array 230 are in the compact position as shown in FIG. 27, the arrays 225, 230 overlap and may be contained and stored above center panel 245. When the arrays 225, 226 are deployed and extended, center panel 245 may be exposed. When in the deployed configuration illustrated in FIG. 28 (and FIGS. 32 and 33), the system 185 may have a deployed-to-transport ratio of 4:1 or greater and may reach a deployed-to-transport ratio of 16:1. In other embodiments, right slide array 225 may be positioned and located above left slide array 230, so long as right slide array 225 and left slide array 230 may complimentarily slide within the unit 185 such that one array is stacked on top of the other array and to the arrays 225, 230 do not collide when returned to the compact form illustrated in FIG. 27.

FIG. 29 illustrates an array lock shown generally at 220 that may prevent the array 225, 230 from deploying or extending from mobile solar power system 185 while the system is in transit or is otherwise unready to be deployed. In the illustrated embodiment, the array lock is in the form of a star lock 235. A user may unscrew lock 235 such that an array 225, 230 is no longer attached to mobile solar power system 185 and may freely slide therefrom. Other locks, latching mechanisms, or means for securing arrays 225, 230 to mobile solar power system 185 and prevent arrays 225, 230 from prematurely sliding away from and extending from mobile solar power system 185 are contemplated herein, as understood in the art.

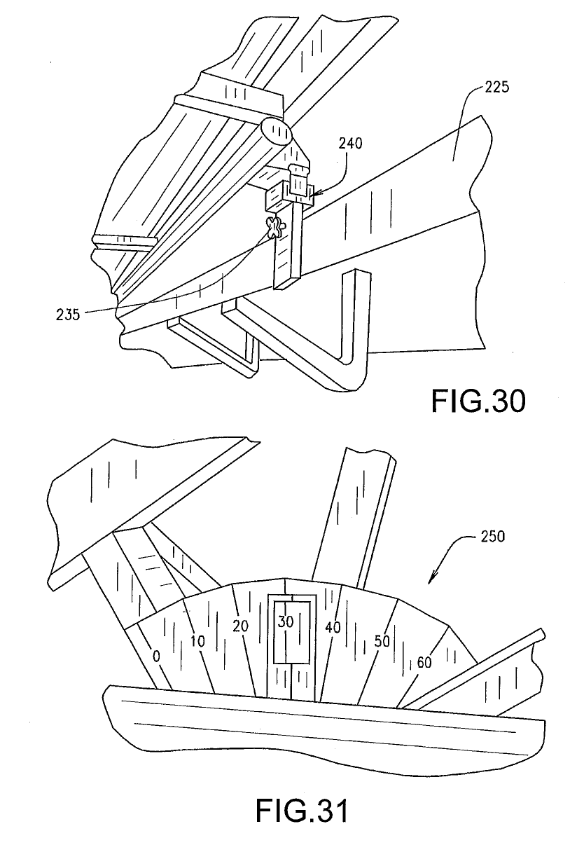

FIG. 30 illustrates right slide array 225 after array lock 220 has been unlocked such that right slide array 225 may slide away from the mobile solar power system 185. FIG. 30 further illustrates a pinning mechanism 240 that may secure right slide array 225 to a center panel 245 associated with the unit 185. Pinning mechanism 240 also may use a star screw 235 substantially similar to star screw 235 illustrated in FIGS. 27 and 29 to secure right slide array 225 in its extended, deployed position. In alternative embodiments, other means for securing right slide array 225 in its extended, deployed position may be used.

FIG. 31 illustrates an angle guide 250 which may be used to control an angle actuator which in structure and function is substantially similar to that angled actuator 175 illustrated in FIG. 26 to tilt right slide array 225, left slide array 230 and center panel 245 such that arrays 225, 230 and center panel 245, and solar panels 250 associated therewith (illustrated in FIGS. 32 and 33), are exposed to sunlight. The angled actuator (not illustrated) may be controlled via electronics positioned and located in electronic compartment 215 or elsewhere, including but not limited to a remote control substantially similar to remote control 140 in mobile solar power system 1.

When a remote control such as remote control 140 activates the angled actuator, or the angled actuator is otherwise manually activated, the angled actuator may use hydraulic methods substantially similar to those described herein above for tilting the arrays of mobile solar power system 1.

FIGS. 32 and 33 illustrate the arrays 225, 230 and center panel 245 as well as solar panels 250 thereof tilted in order to absorb solar energy. As illustrated, arrays 225, 230 and center panel 245 and solar panels 250 thereof tilt in the direction from front portion 200 to rear portion 205, though an alternative embodiment is envisioned herein where they tilt in the direction from rear portion 205 to front portion 200.

In order to return mobile power system 185 to its compact form, the steps described herein should be completed in reverse order. After returning mobile solar power system 185 to its compact form as illustrated in FIG. 24, trailer 210 may be attached to a truck or other towing vehicle to be returned to a desired location.

As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A mobile solar power system for providing electricity to a separate electrically-powered device, said mobile solar power system comprising:
a trailer for transporting the mobile solar power system to and leveling said mobile solar power system at a remote site;
a front sliding array extendable from a stowed position in said mobile solar power system to an extended position, the front sliding array including a wing arm member for attaching the front sliding array to the mobile solar power system when the front sliding array is in its extended position, the front sliding array having a supporting frame structure secured thereto, the frame structure including at least one track secured to a respective one of first and second frame members of the frame structure, the track including a channel or guide member having first and second closed ends, and at least one aperture formed in each of the first and second frame members, the track and at least one aperture being structured and arranged to slideably receive at least one rotational slide pin therein in response to positioning the front sliding array with respect to a ground surface at the remote site;
a rear sliding array extendable from said mobile solar power system;
at least two left folding arrays hingedly associated with a left portion of said mobile solar power system;
at least two right folding arrays hingedly associated with a right portion of said mobile solar power system;
a center array attached to a top portion of said mobile solar power system; and
an angled actuator positioned and located within said mobile solar power system.

2. The mobile solar power system of claim 1, wherein the at least two right folding arrays include an outer folding array, an inner folding array, and a center folding array.

3. The mobile solar power system of claim 1 wherein the at least two left folding arrays include an outer folding array, an inner folding array, and a center folding array.

4. The mobile solar power system of claim 1, wherein the front sliding array includes a wing arm member for attaching the rear sliding array to the mobile solar power system when the front sliding array is in its extended position.

5. The mobile solar power system of claim 4, wherein the front sliding array having a supporting frame structure secured thereto, the frame structure including at least one track secured to a respective one of a first and second frame members of the frame structure, the track including a channel or guide member having first and second closed ends, and at least one aperture formed in each of the first and second frame members, therein, the track and at least one aperture being structured and arranged to slideably receive at least one rotational slide pin therein in response to positioning the rear sliding array with respect to a ground surface at the remote site.

6. The mobile solar power system of claim 1, wherein the at least two left folding arrays each include a wing arm member for being attached with one another.

7. The mobile solar power system of claim 1, wherein the at least two right folding arrays each include a wing arm member for being attached with one another.

8. The mobile solar power system of claim 1, wherein the trailer includes a plurality of outriggers for leveling the mobile solar power system.

9. The mobile solar power system of claim 8, wherein each outrigger is further associated with a jack for securing the mobile solar power system on a ground surface, the plurality of outriggers and jacks further including a control device and leveling mechanism operatively connected thereto and adapted to automatically level the mobile power system on a variety of ground surfaces at a remote site.

10. The mobile power system of claim 1 wherein the power system has a transport configuration having a predetermined footprint size and a deployed configuration having a predetermined footprint size, the ratio of the deployed configuration footprint size to the transport configuration footprint size being greater than 4:1.

11. A mobile solar power system for providing electricity to a separate electrically-powered device, said mobile solar power system comprising:
a trailer for transporting and leveling said mobile solar power system;
a left slide array extendable from said mobile solar power system, said left slide array comprising a plurality of solar panels;
a right slide array extendable from said mobile solar power system, said right slide array comprising a plurality of solar panels;
a center panel comprising a plurality of solar panels, said center panel positioned and located below said left slide array and said right slide array; and
an angled actuator positioned and located within said mobile solar power system.

12. The mobile solar power system of claim 11, wherein the trailer includes a plurality of outriggers for leveling the mobile solar power system.

13. The mobile solar power system of claim 12, wherein each outrigger is further associated with a jack for securing the mobile solar power system on a ground surface.

14. The mobile solar power system of claim 11, wherein the left slide array and right slide array may be positioned and located on top of one another when in the stowed position.

15. The mobile solar power system of claim 11, wherein the mobile solar power system includes an angle guide for operating the angled actuator of the mobile solar power system.

16. The mobile solar power system of claim 11, wherein the mobile solar power system includes an electronic compartment for selectively attaching thereto at least one separate electrically-powered device.

17. The mobile solar power system of claim 11, wherein the right slide array includes an array lock associated therewith for securing the right slide array to the center panel when the right slide array is in its extended position.

18. The mobile solar power system of claim 11, wherein the left slide array includes an array lock associated therewith for securing the left slide array to the center panel when the left slide array is in its extended position.

19. The mobile solar power system of claim 11, wherein the right slide array, the center panel, and the right slide array are tilted from a rear side of the trailer to a front side of the trailer when the mobile solar power system is in its deployed position.
